(19) United States
(12) Patent Application Publication
(10) Pub. No.: US 2008/0249740 A1
(43) Pub. Date: Oct. 9, 2008

(54) Device to Determine the Road Followed By a Person on Foot

(76) Inventor: Koen Verhaert, Antwerpen (BE)

Correspondence Address: BACON & THOMAS, PLLC, 625 SLATERS LANE, FOURTH FLOOR, ALEXANDRIA, VA, 22314-1176, US

(21) Appl. No.: 10/586,911

(22) PCT Filed: Jan. 26, 2005
(86) PCT No.: PCT/BE05/00010

§ 371 Date: Jul. 24, 2006

(30) Foreign Application Priority Data
Feb. 24, 2004 (BE) 2004/0102

(51) Int. Cl. G01C 22/00

(52) U.S. Cl. 702/160

(57) ABSTRACT

Device to determine the road followed by a person on foot, comprising at least three inertia sensors attached to the body of the person, one sensor to the torso and one sensor to each leg respectively, and which measure the absolute orientation of the part of the body concerned to which they are attached; a device which make it possible to determine the instant at which the person concerned takes a step; an arithmetic unit with which the sensors and the above mentioned means are connected, with arithmetic unit comprises a first algorithm which makes it possible, on the basis of a number of body dimensions of the person concerned and on the basis of the signals coming from the above mentioned sensors, to determine at least the step distance for every step as well as the cumulative step distance as of a certain starting point.

The present invention concerns a device to determine the road followed by a person on foot, more particularly to determine the covered distance and/or the followed route.

Such devices are already known under the term “Global Navigation System”, for example devices of the type “Gallileo”, GPS and the like.

Devices are also known which are based on the mensurations of accelerometers provided on the body of the person concerned and which are coupled to relatively complex peripheral equipment with scanners, cameras and the like.

A disadvantage of such known devices is that they are relatively complex and expensive and that they have only a limited accuracy and reliability.

Another disadvantage is that they usually require a very time-consuming calibration procedure and that they are relatively sensitive to varying magnetic fields, such that they cannot be used just anywhere and for any application whatsoever.

Another disadvantage is that such devices also require a major arithmetic capacity, the consequence being that the results are usually only available with a certain delay, which implies that such devices are not suitable for real time evaluations.

Another disadvantage is that, with such devices, it is not always possible to determine the direction of the movements of the person on foot concerned.

Another disadvantage is that such devices often cannot be used in an autonomous and portable manner.

The present invention aims to remedy one or several of the above-mentioned and other disadvantages.

To this end, the invention concerns a device to determine the road followed by a person on foot, which mainly consists of at least three inertia sensors attached to the body of the person, one sensor to the torso and one sensor to each leg respectively, and which measure the absolute orientation of the part of the body concerned to which they are attached; means which make it possible to determine the instant at which the person concerned takes a step; an arithmetic unit with which the sensors and the above-mentioned means are connected, which arithmetic unit comprises an algorithm which makes it possible, on the basis of a number of body dimensions of the person concerned and on the basis of the signals coming from the above-mentioned sensors, to determine at least the step distance for every step as well as the cumulated step distance as of a certain starting point.

On the basis of a limited number of body data of the person on foot concerned, such as the length of the legs and the distance between the hip joints, it is possible to determine in a relatively simple manner, on the basis of the measurement data of the orientation of the torso and of the legs, at any time, the mutual position of the feet of the person by applying a geometric algorithm in the arithmetic unit.

Thus it becomes possible to determine for every step, in other words each time the person is situated with both feet on the ground, the distance of the step and, by cumulation of the successive distances of the steps, the total distance covered as of a certain starting point.

Preferably, the geometric algorithm is such that also the step direction can be determined, as a result of which it also becomes possible to determine the route followed by the person as of the above-mentioned starting point.

The inertia sensors are preferably applied on the body of the person by means of a tight fitting garment, for example in the shape of trousers or the like, onto which the sensors are attached, in such a manner that they cannot move, or practically cannot move in relation to the torso or the legs.

Such sensors are advantageous in that they are relatively small and, consequently, hardly hinder the user in his/her movements, and moreover in that the measuring results are far less sensitive to fluctuations in the magnetic field, which has for a result that the obtained results are much more precise and reliable than with the known systems.

The device is preferably equipped with a portable electric power supply for the sensors and for the arithmetic unit, as a result of which the device can be used in an autonomous manner without any additional peripheral equipment.

In order to better explain the characteristics of the present invention, the following preferred embodiments of a device according to the invention are given as an example only without being limitative in any way, with reference to the accompanying drawings, in which:

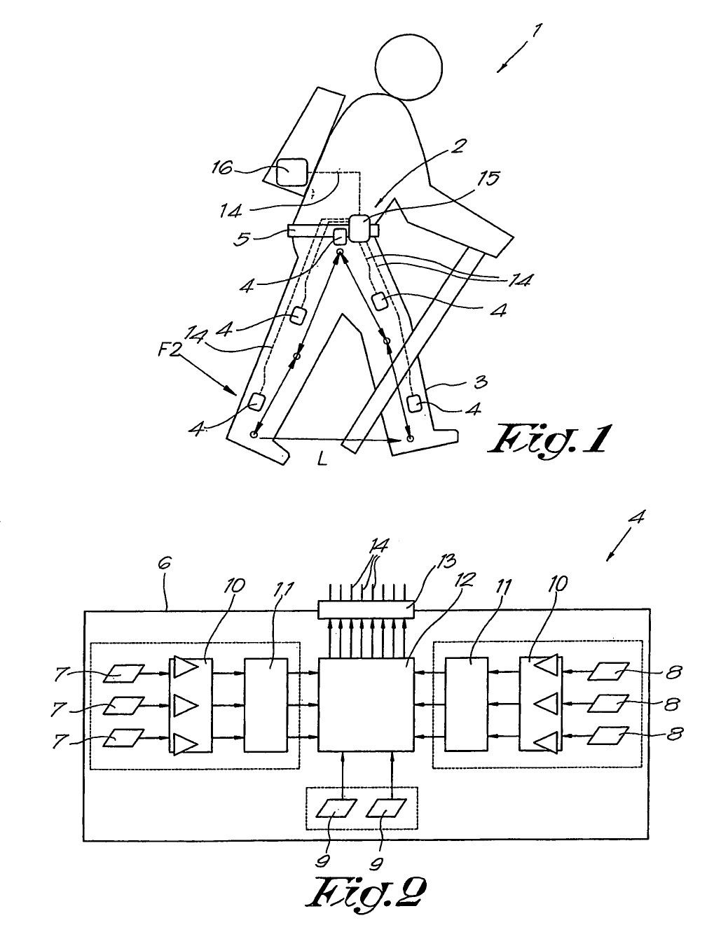

FIG. 1 schematically represents a person on foot, equipped with a device according to the invention;

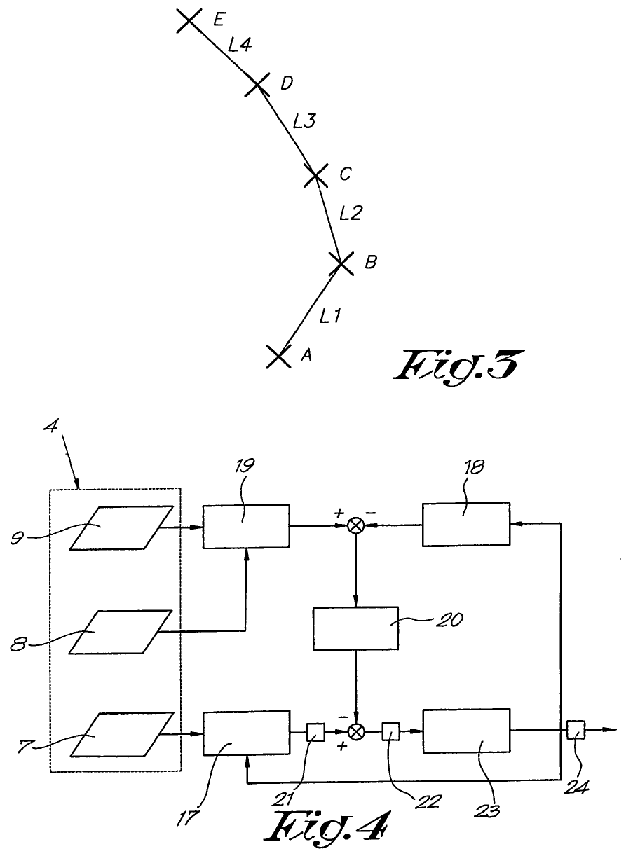

FIG. 2 is a block diagram of a sensor which is indicated by arrow F2 in FIG. 1;

FIG. 3 indicates the road followed by the person on foot;

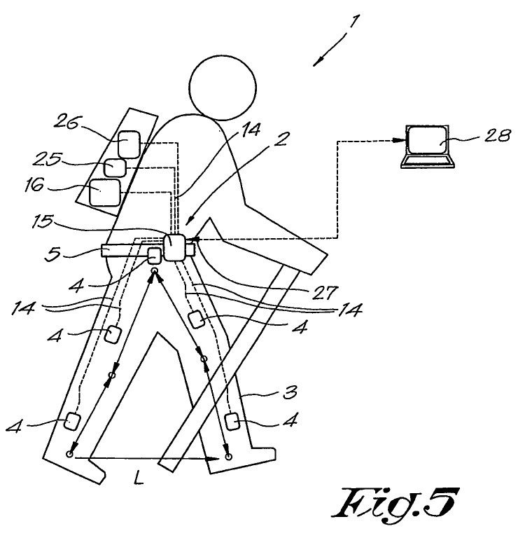

FIG. 4 represents a block diagram of a Kalman filter, as applied in the device of FIG. 1;

FIG. 5 represents a variant of FIG. 1.

FIG. 1 represents a person 1 who is equipped with a device 2 according to the invention.

In the given example, the device 1 consists of a garment 3 in the form of trousers or the like fitting tightly to the body of the person 1 and onto which are provided five small light-weight sensors 4, more particularly what are called inertia sensors, one sensor 4 of which is attached to the torso, for example by means of a belt 5, whereas the other sensors 4 are attached to the legs, more particularly to the upper legs and to the lower legs.

The textile fabric out of which the garment 3 is made, is preferably characterised in that it is easily washable and lets perspiration through, is comfortable to wear and is in good contact with the body, such that the sensors 4 do not shift on the body while the person 1 moves, and moreover, thanks to the elasticity of the fabric, does not hinder the person's movements.

Each of the above-mentioned sensors 4 is formed of a housing 6 in which, as represented in FIG. 2, a number of microsensor elements have been provided, namely three gyroscopes 7 which measure the absolute angular velocity according to three mutual directions which are preferably at right angles; two or in this case three magnetometers 8 measuring the terrestrial magnetism and together forming an electronic compass to measure the azimuth of the sensor 4, more particularly the azimuth of a fixed coordinate system of the sensor 4 which serves as a reference; and finally two accelerometers 9 which measure the acceleration of the sensor 4 according to the above-mentioned three perpendicular directions and which together form an electronic spirit level to measure the inclination and the rolling position of the sensor 4, more particularly the inclination and rolling position of the above-mentioned fixed coordinate system of the sensor 4 which serves as a reference.

Other possible embodiments of sensors 4 are not excluded. Thus, for example, also double-axled magnetometers and two double-axled accelerometers may be used. What is important is that the magnetometers and accelerometers allow for measurements in three directions which are not situated in the same plane, for example according to three orthogonal directions, for example a vertical direction and two perpendicular horizontal directions.

The output signals of the above-mentioned microsensor elements 7-8-9 are connected, possibly after having been amplified by an amplifier 10 and after having been converted by an analog-to-digital converter 11, to a microprocessor 12 which in this case forms a data buffer for the measurement data of the sensor 4 and whose output signal, as will be further explained, is a measurement for the absolute orientation of the body part onto which the sensor 4 concerned is attached, namely the torso and the upper and lower legs. The absolute orientation is determined for example by the azimuth, the inclination and the rolling position of the sensor 4.

The above-mentioned output signal is connected, either or not via a plug connection 13, by means of a cable 14, to an arithmetic unit 15 which is carried by the person 1, for example on the belt 5.

The arithmetic unit 15 and the sensors 4 are fed by a battery 16 or any other form of power supply whatsoever, such as solar cells or the like, which is preferably portable.

The arithmetic unit is provided with a first algorithm which makes it possible, on the basis of the signals of the sensors 4 on the one hand, and the body dimensions of the person concerned on the other hand, more particularly the length of the upper and lower legs and the distance between the hip joints, to calculate the position of the feet of the person at any time, by means of a geometric vector calculation which is understood by any professional and which, consequently, will not be treated any further in detail here.

Further, the arithmetic unit comprises a second algorithm which makes it possible, on the basis of the signals of the accelerations of the accelerometers 9 of the sensors 4, to determine when the person 1 makes contact to the ground with his feet, on the basis of which the instant can be derived at which the person has made a step when he touches the ground with both feet. Also this second algorithm is understood by any professional.

The working of the device 2 according to the invention is as follows.

When the person 1 is walking, the arithmetic unit successively receives the data of the sensors 4 at a certain frequency.

On the basis of these data, by means of the second algorithm, the instant at which the person 1, after he has taken a step, sets his foot on the ground, is determined.

At that moment the second algorithm determines the position of the feet of the person 1, from which the distance of the step L, as well as the step direction of the person 1 can be determined.

As represented in FIG. 3, it is possible to calculate the total distance of the step (L1+L2+L3+ . . . ) as of a certain starting point A, as well as the following route ABCDE, by successively calculating the distance of the step L and the direction of each step, in a simple manner by cumulating the results of the calculations.

This allows the person concerned to know his/her position at any time, as well as the distance which he/she has already covered.

The results of the calculation can for example be visualised on a screen of the arithmetic unit.

The arithmetic unit uses the dimensions of the legs of the person 1 and the distance between the hip joints.

These dimensions can be measured on the person 1 concerned and they can subsequently be put in in the arithmetic unit via a keyboard or the like.

Another possibility to put in these data, is by calibrating the device.

In order to determine the length of the upper legs and the distance of the hip joints, the person 1 concerned will sit for example with his knees on the ground, with his knees at a certain distance from each other, after which, after the signals of the sensors 4 for this position have been read, the desired dimensions can be calculated by means of a reverse calculation of the first algorithm.

The length of the lower legs can then be determined, for example, by making a step with a known distance of the step L and by subsequently, on the basis of the measurements of the sensors 4, making a reverse calculation with the first algorithm.

Thus, such a calibration is very simple and requires no special additional equipment, as is often the case with the known devices.

As will appear from what precedes, each sensor 4 provides a signal of the absolute orientation of the sensor 4 concerned, characterised by an azimuth, an inclination and a rolling position in the following manner.

Gyroscopes 7 are generally very suitable for measuring orientation changes, also during (relatively) fast movements. The output signals of the gyroscopes 7 are, as is known, in proportion to the angular speed at which they move. By integrating this output signal arithmetically in time, an absolute angular orientation position of the gyroscope 7 is obtained, and thus also of the sensor 4 in which the latter is integrated.

From practice we know that, by integrating the output signal of a gyroscope, an increasing deviation is always created, commonly known as the drift of a gyroscope 7.

In order to eliminate the above-mentioned drift, the microprocessor 12 or the arithmetic unit 15 compares the absolute orientation, which is obtained on the basis of the signals of the gyroscopes 7, to the absolute orientation which is determined by the signals of the above-mentioned magnetometers 8 and the accelerometers 9, and the necessary correction is made on the basis of this comparison.

The above-mentioned drift of each sensor 4 is corrected by means of software by applying a filter of what is called the Kalman type.

The working of such a Kalman filter is illustrated by means of the block diagram of FIG. 4.

The signals coming from the gyroscopes 7 are evaluated by a certain software algorithm 17 known as such, and they are converted into a best estimated value 18 of the absolute orientation of the sensor 4, characterised by an azimuth, an inclination and a rolling position. Said best estimated value 18 is then compared to the value 19 of the absolute orientation of the sensor 4, characterised by the azimuth, inclination and rolling position, measured by the magnetometers 8 and the accelerometers 7, which leads to a correction signal 20 in order to correct the drift.

This correction signal 20 is then subtracted from the signal 21 measured by the gyroscopes 7, such that, after a signal 22 has been corrected, after the integration by integration software 23, a correct value 24 of the absolute orientation of the sensor 4 concerned is obtained, which is then further used by the first algorithm in order to calculate the above-mentioned distance of the steps and step directions.

FIG. 5 represents a variant of a device according to the invention as described above, whereby the device is expanded in this case with the following elements:
a positioning system 25 which is coupled to the above-mentioned arithmetic unit 15, for example in the form of a GPS-system;
means 26 for realising a wireless connection with an external communication network;
a connection 27 to make a connection with an external computer or PC 28.

By combining the signals of the positioning system 25 and of the calculation results of the arithmetic unit 15, one obtains a very competitive system to determine the position of the person 1, whereby these calculation results so to say complete the data coming from the positioning system, as a result of which the position of the person 1 can be determined with great accuracy and reliability.

Thank to the wireless connection, the position of the person 1 can be transferred in a wireless manner via a communication network to an external receiver, such that the movements of the person can be followed from a distance.

Thanks to the connection 27, the data of the arithmetic unit 15 can be read via an external computer 28. For a further evaluation or processing of these data, the algorithms can be loaded and updated, and the data of the users can be put in.

Although in the above-mentioned example, the device 2 is equipped with five sensors 4, it is not excluded to use only three sensors 4, namely one on the torso and one on each leg, more particularly one on each upper leg or one on each lower leg.

The second algorithm which makes it possible to determine the instant at which the person 1 takes a step, can also be replaced by other means which make it possible to determine when the person, after having made a step, sets his foot on the ground, for example by pressure sensors which are built in in the soles of the person 1 and which are connected to the arithmetic unit 15.

It is clear that the above-mentioned device can also be used on animals, on robots or the like, for example in order to be able to follow their movements.

The present invention is by no means limited to the embodiments given as an example and represented in the accompanying drawings; on the contrary, such a device according to the invention can be made in all shapes and dimensions while still remaining within the scope of the invention.

1-14. (canceled)

15. Device to determine the road followed by a person on foot, comprising at least three inertia sensors attached to the body of a person, one of said sensors attached to the torso and one of said sensors attached to each leg respectively, and wherein said sensors are arranged to measure the absolute orientation of the part of the body to which they are attached; means which make it possible to determine the instant at which the person takes a step; an arithmetic unit to which the sensors and the means which make it possible to determine the instant at which the person takes a step are connected, said arithmetic unit comprising a first algorithm which enables, on the basis of a number of body dimensions of the person concerned and on the basis of the signals coming from the at least three sensors, a determination to be made of at least the step distance for every step taken by the person as well as the cumulative step distance from a defined starting point.

16. Device according to claim 15, wherein the algorithm enables the determination of the direction of every step, as well as the route followed by the person from the defined starting point.

17. Device according to claim 15, wherein the inertia sensors attached to the legs are located on the upper legs.

18. Device according to claim 15, wherein the inertia sensors attached to the legs are located on the lower legs.

19. Device according to claim 15, wherein said at least three inertia sensors include inertia sensors attached to both the upper legs and the lower legs.

20. Device according to claim 15, including one or several garments which fit tightly onto the torso and onto the legs of the person and wherein said inertia sensors are attached to said garments.

21. Device according to claim 15, including an electric power supply for the sensors and for the arithmetic unit, which power supply is carriable by the person.

22. Device according to claim 15, wherein the inertia sensors include at least two gyroscopes which are oriented according to mutual directions, at least one magnetometer and at least one accelerometer.

23. Device according to claim 22, including a microprocessor, and wherein each of the sensors is integrated with the microprocessor.

24. Device according to claim 23, including a software filter of the Kalman type arranged to correct for the drift of the gyroscopes by comparing the signals of the gyroscopes with the signals of the magnetometers and accelerometers.

25. Device according to claim 15, wherein the means which make it possible to determine the instant at which the person takes a step comprises a second algorithm in the arithmetic unit which makes it possible, on the basis of the signals of the accelerometers of the inertia sensors, to determine when the person is situated with both feet on the ground.

26. Device according to claim 15, including a positioning system which is coupled to the arithmetic unit.

27. Device according to claim 15, including means to establish a wireless connection with a communication network.

28. Device according to claim 15, including a connection enabling communication with a computer.
